(19) United States
(12) Patent Application Publication
(10) Pub. No.: US 2023/0008997 A1
(43) Pub. Date: Jan. 12, 2023

(54) SYSTEM AND METHOD FOR SUPER-HEAT REMOVAL IN PACKED DISTILLATION COLUMN

(71) Applicants: Arya Ayaskanta, Tonawanda, NY (US); Kirk F. Larson, Amherst, NY (US); Di Song, East Amherst, NY (US); Steven C. Brown, Amherst, NY (US)

(72) Inventors: Arya Ayaskanta, Tonawanda, NY (US); Kirk F. Larson, Amherst, NY (US); Di Song, East Amherst, NY (US); Steven C. Brown, Amherst, NY (US)

(21) Appl. No.: 17/369,139

(22) Filed: Jul. 7, 2021

(51) Int. Cl. B01D 3/22; B01D 3/32; B01D 3/00

(52) U.S. Cl. CPC B01D 3/22; B01D 3/324; B01D 3/008

(57) ABSTRACT

A system and method for reducing a vapor temperature in a packed distillation column. Liquid is collected from a packed section of the packed distillation column in a liquid collector disposed below the packed section. A super-heated vapor is distributed from a vapor feed disposed below the packed section such that the super-heated vapor contacts the liquid of the liquid collector and reduces a temperature of the super-heated vapor.

### FIELD

The present disclosure relates generally to packed distillation columns, and more particularly, to a method for removing super-heat from column vapor feeds.

### BACKGROUND

Generally, packed distillation columns are zones where liquid and vapor phases are concurrently contacted to effect separation of a fluid mixture through contacting of the vapor and liquid phases on packing elements or on a series of vertically spaced trays mounted within the column. A dual column includes a higher-pressure column (e.g., lower column (LC)) with its upper end in heat exchange relation with the lower end of a lower-pressure column (e.g., higher column (HC)).

A column section is a zone in the column having a top or bottom where vapor or liquid is removed from or enters a column. Structured packing within a section of a column has been developed as a mass transfer element because it has a lower pressure drop than trays and has more predictable performance than random packing. Structured packing is packing with individual members with specific orientations relative to each other and to the column axis. However, when hydraulic loads are substantially different in different sections of a column, one or more sections may be closer to flooding than other sections.

Within a dual column system, the LC having the higher pressure may have vapor feeds with a 5 degree K or more super-heat. A section of the LC that is packed with structured packing (LC−1 section) may be trayed to avoid maldistribution of the super-heated vapor and uneven liquid boil off from the structured packing of the LC−1 section. The trayed LC−1 section adds to the pressure drop of the LC compared to a case in which the entire LC is packed with structured packing. If boil off occurs unevenly on the surface of the structured packing, the maldistribution leads to performance shortfalls.

### SUMMARY

According to one embodiment, a system is provided for reducing a vapor temperature in a packed distillation column. The system includes a packed section of the packed distillation column. The system also includes a liquid collector disposed below the packed section and collecting liquid from the packed section. The system further includes a vapor feed disposed below the packed section and distributing a super-heated vapor such that the super-heated vapor contacts the liquid of the liquid collector and reduces a temperature of the super-heated vapor.

According to one embodiment, a method is provided for reducing a vapor temperature in a packed distillation column. Liquid is collected from a packed section of the packed distillation column in a liquid collector disposed below the packed section. A super-heated vapor is distributed from a vapor feed disposed below the packed section such that the super-heated vapor contacts the liquid of the liquid collector and reduces a temperature of the super-heated vapor.

### BRIEF DESCRIPTION OF THE DRAWINGS

The above and other aspects, features, and advantages of certain embodiments of the present disclosure will be more apparent from the following detailed description, when taken in conjunction with the accompanying drawings, in which:

FIG. 1 is a diagram illustrating a packed LC−1 section of a dual column system, according to an embodiment of the disclosure;

FIG. 2 is a diagram illustrating a de-superheating collector tray, according to an embodiment of the disclosure;

FIG. 3 is a diagram illustrating a vapor feed configuration, according to an embodiment of the disclosure;

FIG. 4 is a flowchart illustrating a method for reducing a vapor temperature in a packed distillation column, according to an embodiment of the disclosure; and

FIG. 5 is a block diagram illustrating a controller for reducing a vapor temperature in a packed distillation column, according to an embodiment of the disclosure.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate the existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

Embodiments of the present disclosure provide a self-supporting de-superheating collector tray below a packed column section. The de-superheating collector tray serves two purposes. First, the tray collects liquid falling from the structured packing above. Thus, the structured packing does not require a separate collector. Second, due to the pressure drop, the tray evenly distributes the incoming super-heated vapor feed, bringing it into contact with the collected liquid. Accordingly, any vaporization that occurs will be uniform, resolving any potential maldistribution issues in the structured packing above.

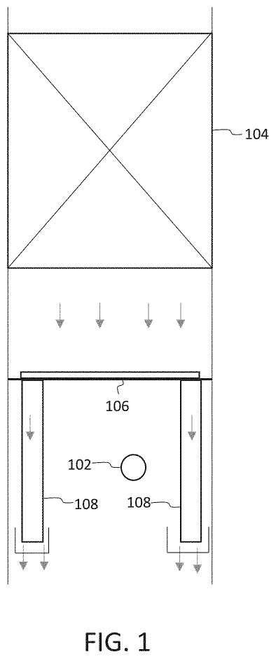

FIG. 1 is a diagram illustrating a packed column section of a packed distillation column, according to an embodiment of the disclosure. Super-heated vapor is fed from a vapor feed 102 into a packed column section 104. The packed column section may be embodied as a higher-pressure lower column. A self-supporting de-superheating collector tray 106 collects liquid falling from the packed column section 104. A separation is provided between the collector tray 106 and the packed column section 104. For example, the separation may be 8-10 inches. The vapor feed 102 is disposed, as close as possible, below collector tray 106. The separation between the vapor feed 102 and the collector tray 106 may be based on a calculation using an amount of froth in the collector tray 106. Vapor directly from the vapor feed is evenly distributed among perforations in a surface of the collector tray 106, such that it is brought into contact with the collected liquid. This direct contact decreases the super-heated nature of the vapor as it passes through the collected liquid in the collector tray 106 to the packed column section 104. Excess liquid within the collector tray 106 funnels out via downcomers 108 to a collector sump.

The packed column section of FIG. 1 may be embodied as a packed LC−1 section of a dual column air separation system. Additionally, the packed column section may be structured or random. However, embodiments of the disclosure are not limited to an LC−1 section of a dual column system, but may also be applied to any superheated feed below any packed section. For example, according to an embodiment, the vapor feed 102 may be an intermediate feed having packed sections disposed above and below. The intermediate feed rate would have a high percentage of the overall vapor traffic.

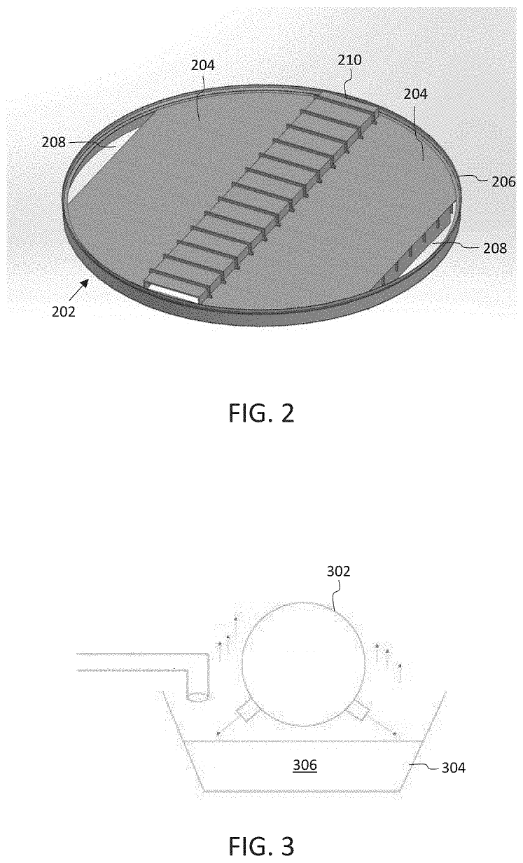

FIG. 2 is a diagram illustrating a perspective view of a de-superheating collector tray, according to an embodiment of the disclosure. Specifically, FIG. 2 is a detailed description of the collector tray 106 of FIG. 1. A collector tray 202 has a perforated deck 204 that receives the liquid falling from the packed column section. A circumferential edge or lip 206 surrounds the perforated deck 204, and keeps the liquid on the collector tray 202. Simultaneously, super-heated vapor from the vapor feed 102 rises through perforations in the perforated deck 204 and comes into contact with and passes through the collected liquid. As described above, this removes the super-heated nature of the vapor before rising to the packed column section. Excess liquid that is collected at the perforated deck 204 is funneled off via downcomer cutouts 208, which lead to the downcomers 108 of FIG. 1 and the collector sump. A central support 210 is unperforated and runs across a diameter of the collector tray 202. The central support 210 may be elevated above the perforated deck 204 creating a space for mounting the collector tray 202. The central support 210 supports the collector tray in place below the packed column section 104 of FIG. 1.

Accordingly, when the disclosure is embodied in a packed LC−1 section, the de-superheating collector tray leads to significant pressure drop savings in the LC, which would otherwise have a trayed LC−1 section due to the super-heat of the incoming vapor feed.

In another embodiment. which may be used separately or in combination with the embodiment of FIGS. 1 and 2, a vapor feed is integrated with a trough. The trough receives a portion of the liquid from the collector sump. This builds a liquid pool in the trough. A momentum breaker is added to the liquid pool to prevent splashing. This embodiment removes the super-heat from the air feed through vapor-liquid contact in the trough, and also ensures even vapor distribution by keeping the vapor centered about the column.

FIG. 3 is a diagram illustrating a vapor feed configuration, according to an embodiment of the disclosure. Specifically, the configuration may be a detailed description of the vapor feed 102 of FIG. 1. Alternatively, the configuration may be implemented in a conventional dual-column system. A vapor feed 302 disburses vapor across an even distribution at a downward angle into a trough 304. At least a portion of the liquid that is typically provided to the collector sump is diverted to the trough 304. Accordingly, the super-heated vapor is directed into a liquid pool 306 of the trough 304 to reduce the super-heat of the vapor through initial contact with the liquid.

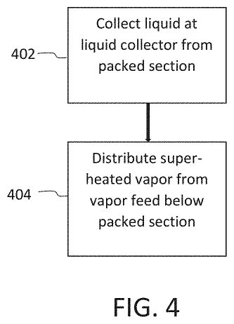

FIG. 4 is a flowchart illustrating a method for reducing a vapor temperature in a packed distillation column, according to an embodiment of the disclosure.

Initially, at 402, liquid is collected, at a liquid collector, from a packed section of the column. The liquid collector is disposed below the packed section.

When the liquid collector is a collector tray disposed above the vapor feed, the liquid collected at the collector tray falls from the packed section. The collector tray includes a perforated deck through which the super-heated vapor contacts the collected liquid.

When the liquid collector is a trough disposed below the vapor feed, the collected liquid is at least a portion of liquid provided from the packed section to a collector sump. An alternative embodiment may include both the collector tray and the trough.

At 404, a super-heated vapor is distributed from a vapor feed disposed below the packed section. The super-heated vapor contacts the liquid of the liquid collector and reduces a temperature of the super-heated vapor.

When the liquid collector is the collector tray disposed above the vapor feed, the super-heated vapor is evenly distributed below the collector tray. When the liquid collector is the trough, the super-heated vapor is evenly distributed downwardly toward a surface of the liquid in the trough.

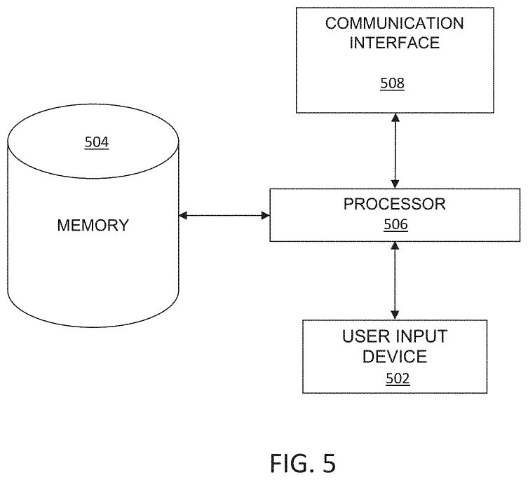

FIG. 5 is a block diagram illustrating a controller for reducing a vapor temperature in a packed distillation column, according to an embodiment. The processor or controller may include at least one user input device 502 and a memory 504. The memory 504 may include instructions that allow a processor 506 to control distribution of super-heated vapor from a vapor feed.

The apparatus also includes the processor 506 for controlling the distribution of super-heated vapor from a vapor feed. Additionally, the apparatus may include a communication interface 508 that receives, transmits, and/or outputs signals.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A system for reducing a vapor temperature in a packed distillation column, the system comprising:
a packed section of the packed distillation column;
a liquid collector disposed below the packed section and collecting liquid from the packed section; and
a vapor feed disposed below the packed section and distributing a super-heated vapor such that the super-heated vapor contacts the liquid of the liquid collector and reduces a temperature of the super-heated vapor.

2. The system of claim 1, wherein the liquid collector comprises a collector tray disposed above the vapor feed, and the collector tray collects the liquid that falls from the packed section.

3. The system of claim 2, wherein the collector tray comprises a perforated deck through which the super-heated vapor contacts the liquid.

4. The system of claim 3, wherein the super-heated vapor is evenly distributed below the collector tray.

5. The system of claim 3, further comprising at least one downcomer that provides the liquid from the collector tray to a collector sump, wherein the collector tray further comprises at least one downcomer cutout through which the liquid flows from the perforated deck to the at least one downcomer.

6. The system of claim 5, further comprising a liquid-filled trough disposed below the vapor feed, wherein the super-heated vapor is initially evenly distributed downwardly toward a surface of a liquid in the trough, and wherein the liquid in the trough is at least a portion of a liquid provided to the collector sump.

7. The system of claim 1, wherein the liquid collector comprises a trough disposed below the vapor feed.

8. The system of claim 7, wherein the super-heated vapor is evenly distributed downwardly toward a surface of the liquid in the trough.

9. The system of claim 7, wherein the liquid received at the trough is at least a portion of a liquid provided from the packed section to a collector sump.

10. The system of claim 1, wherein the vapor feed is an intermediate vapor feed, and further comprising another structured packing section disposed below the liquid collector and the intermediate vapor feed.

11. The system of claim 1, wherein the packed distillation column is a lower column of an air separation unit.

12. A method for reducing a vapor temperature in a packed distillation column, the method comprising:
collecting liquid from a packed section of the packed distillation column in a liquid collector disposed below the packed section; and
distributing a super-heated vapor from a vapor feed disposed below the packed section such that the super-heated vapor contacts the liquid of the liquid collector and reduces a temperature of the super-heated vapor.

13. The method of claim 12, wherein the liquid collector comprises a collector tray disposed above the vapor feed, and collecting the liquid comprises collecting the liquid that falls from the packed section at the collector tray.

14. The method of claim 13, wherein the collector tray comprises a perforated deck through which the super-heated vapor contacts the liquid.

15. The method of claim 14, wherein distributing the super-heated vapor comprises evenly distributing the super-heated vapor below the collector tray.

16. The method of claim 14, further comprising providing the liquid from the collector tray to a collector sump via at least one downcomer, wherein the collector tray further comprises at least one downcomer cutout through which the liquid flows from the perforated deck to the at least one downcomer.

17. The method of claim 16, wherein distributing the super-heated vapor comprises initially evenly distributing the super-heated vapor downward to a surface of a liquid in a trough disposed below the vapor feed, wherein the liquid in the trough is at least a portion of a liquid provided to the collector sump.

18. The method of claim 12, wherein the liquid collector comprises a trough disposed below the vapor feed.

19. The method of claim 18, wherein distributing the super-heated vapor comprises evenly distributing the super-heated vapor downwardly toward a surface of the liquid in the trough.

20. The method of claim 18, wherein the liquid received at the trough is at least a portion of a liquid provided from the packed section to a collector sump.

21. The method of claim 12, wherein the vapor feed is an intermediate vapor feed and another structured packing section is disposed below the liquid collector and the intermediate vapor feed.

22. The method of claim 12, wherein the packed distillation column is a lower column of an air separation unit.
